(19) United States
(12) Patent Application Publication
(10) Pub. No.: US 2013/0140375 A1
(43) Pub. Date: Jun. 6, 2013

(54) SPRAYING APPARATUS AND METHODS AND COMPONENTS RELATING TO SPRAYING APPARATUS

(71) Applicants: Campbell Bryce Easton, Dannevirke (NZ); Geoffrey James Easton, Dannevirke (NZ); Nicholas Roy Longstaff, Dannevirke (NZ)

(72) Inventors: Campbell Bryce Easton, Dannevirke (NZ); Geoffrey James Easton, Dannevirke (NZ); Nicholas Roy Longstaff, Dannevirke (NZ)

(21) Appl. No.: 13/700,420

(22) PCT Filed: May 24, 2011
(86) PCT No.: PCT/NZ2011/000086

§ 371 Date: Feb. 19, 2013

(30) Foreign Application Priority Data
May 28, 2010 (NZ) 585757
Nov. 17, 2010 (NZ) 589337

(51) Int. Cl. B05B 7/26; B05B 12/00

(52) U.S. Cl. CPC B05B 7/26; B05B 12/00
USPC 239/124; 239/310; 239/172; 239/302

(57) ABSTRACT

A spraying apparatus that is particularly suited to spraying of suspensions, for example liquid suspended fertilizers. The apparatus includes a tank with an inlet configured to create fluid circulation within the tank, thereby reducing settling of solids out of suspension. A mixing unit improves the mixing of particulates with fluids as they are added to the tank. Spray outlets are arranged in a flow loop and only a proportion of fluid passing through the flow loop is sprayed with the remaining fluid returning to the tank for recirculation. Pressure-actuated closures may be used to prevent spraying until pressure has built up sufficiently.

### FIELD OF THE INVENTION

The invention relates to a spraying apparatus, particularly but not exclusively to an apparatus for spraying suspended particulate and/or biologically active material in agricultural or horticultural settings. The invention also relates to spraying methods and components of spraying apparatuses.

### BACKGROUND TO THE INVENTION

Sprays are widely used in various applications, including horticultural and agricultural applications. Sprays include fertilizers and chemicals for pest or disease control. Liquid sprays may be sprayed directly or diluted with water. Particulate sprays may be dissolved in water or, for insoluble or partially soluble materials, suspended in water for spraying. Recently various biologically active sprays have been proposed and these are applied in a similar manner.

Sprays are typically applied by a trailer or vehicle-mounted sprayer.

Application of fine powders in suspension is desirable because it provides faster chemical uptake and reduces undesirable runoff into waterways. However, fine powders are difficult to apply. Prior sprayers suffer from poor formation or maintenance of the suspension (i.e. the powder does not mix adequately with water or settles out after mixing but before spraying). If powder settles from the suspension it can solidify into an extremely hard substance which is difficult to clean. The settled powder is also wasted. These difficulties also lead to undesirable variation in application rates and increased costs.

It is an object of the invention to provide an improved spraying system and/or spraying method or at least to provide the public with a useful choice.

### SUMMARY OF THE INVENTION

In a first aspect the invention provides a spraying apparatus including: a tank; a fluid inlet through which, in use, fluid flows into the tank; and a pump arranged to cause flow of fluid through the fluid inlet into the tank; wherein the fluid inlet is positioned at or near the bottom of the tank and is configured to create flow substantially across the bottom of the tank at least in the region of the inlet.

Preferably the fluid inlet is positioned substantially towards the back front or side of the tank and at or near the bottom of the tank.

Preferably the fluid inlet is directed towards but at an acute angle to a wall of the tank.

Preferably the apparatus includes a Venturi arrangement at or near the fluid inlet.

The spraying apparatus may include a baffle positioned within and above the bottom of the tank to direct flow from the fluid inlet substantially across the bottom of the tank. Preferably the baffle is a plate baffle. Preferably the position of the baffle is adjustable. Preferably adjustment of the baffle alters the flow pattern within the tank. Preferably adjustment of the baffle alters a spraying pressure at which fluid to be sprayed is supplied to one or more spray outlets. Preferably the fluid inlet opens into a space between the bottom of the tank and the baffle. Preferably a fluid outlet is positioned near the fluid inlet but on the other side of the baffle.

Preferably the apparatus includes a fluid outlet through which fluid can be pumped from the tank.

The fluid outlet may be positioned near but shielded from the fluid inlet in order to encourage a flow pattern from the region of the fluid inlet substantially across the bottom of the tank, then upwards and returning to the outlet.

Preferably the spraying apparatus includes a mixing unit with an intake for introduction of a material to be sprayed into the mixing unit and a fluid inlet for introduction of fluid into the mixing unit, an outlet from the mixing unit leading directly or indirectly to the tank; wherein the mixing unit is configured to cause turbulent flow of fluid that is introduced from the fluid inlet to promote mixing of the material and the fluid.

Preferably the material to be sprayed is a particulate material.

Preferably one or more structural features are provided within the mixing unit to cause the turbulent flow. Preferably the structural features include one or more plates, obstructions, baffles, walls, ramps, deflectors.

Preferably the pump, or a further pump, is arranged to maintain a recirculating flow from the tank through the mixing unit and back to the tank substantially continuously while the spraying apparatus is in use.

Preferably the spraying apparatus includes a flow loop leading from the tank and returning to the tank and one or more spray outlets positioned in the flow loop; the pump, or a further pump, being arranged to cause flow of fluid from the tank through the flow loop, and the apparatus being configured such that, during spraying, only a portion of fluid passing through the flow loop exits through the spray outlets, with the remainder of the fluid returning to the tank for recirculation.

Preferably the flow loop includes one or more spray booms, one or more of the spray outlets being positioned in each spray boom.

Preferably a spray valve is positioned downstream of the spray outlets, the spray valve having an open position and at least one restricted flow position, wherein the pressure at the spray outlets is higher when the spray valve is in the restricted flow position than when it is in the open position.

Preferably the spraying apparatus is configured to spray less than 20% of fluid passing through the flow loop. Preferably the spraying apparatus is configured to spray around 3 to 10% of fluid passing through the flow loop.

Preferably the spraying apparatus is configured to supply fluid to the flow loop at a rate in the range 500 to 800 litres per minute.

Preferably the spraying apparatus includes at least one pressure-actuated closure controlling flow to one or more of the spray outlets, such that fluid is permitted to flow from the flow loop to those one or more spray outlets only when the pressure in the flow line is sufficient to cause the pressure-actuated closure to open.

Preferably the pressure-actuated closure includes a membrane configured to move under sufficient pressure to open the closure.

Preferably the spraying apparatus includes a user-operated override mechanism to prevent undesired opening of the pressure-actuated closure.

Preferably the spraying apparatus is configured as a trailer for towing behind a vehicle or configured to be mounted on a vehicle.

Preferably the spraying apparatus is configured to operate at a pressure less than 35 pounds per square inch. Preferably the spraying apparatus is configured to operate at a pressure less than 30 pounds per square inch. Preferably the spraying apparatus is configured to operate at a pressure less than 25 pounds per square inch.

Preferably the spraying apparatus is configured to maintain a particulate in suspension in the tank for spraying.

Preferably the material to be sprayed is or includes a particulate material and is sprayed in suspension. Preferably the particulate has an average particle size less than 100 microns. Preferably the particulate has an average particle size less than 50 microns. Preferably the particulate has an average particle around 5 microns.

Preferably the material to be sprayed is or includes a component that is biologically active.

Preferably the spraying apparatus is an agricultural or horticultural spraying apparatus.

In a second aspect the invention provide a spraying apparatus including: a mixing unit with an intake for introduction of a material to be sprayed into the mixing unit and a fluid inlet for introduction of fluid into the mixing unit; and a tank, an outlet from the mixing unit leading directly or indirectly to the tank; wherein the mixing unit is configured to cause turbulent flow of fluid that is introduced from the fluid inlet to promote mixing of the material and the fluid.

Preferably the material to be sprayed is or includes a particulate material.

Preferably one or more structural features are provided within the mixing unit to cause the turbulent flow. Preferably the structural features include one or more plates, obstructions, baffles, walls, ramps, deflectors.

Preferably the apparatus includes a pump arranged to cause fluid to flow from the tank to the fluid inlet for introduction of fluid into the mixing unit, the fluid then flowing from the mixing unit back to the tank.

Preferably the pump is arranged to maintain a recirculating flow from the tank through the mixing unit and back to the tank substantially continuously while the spraying apparatus is in use.

Preferably the spraying apparatus includes a flow loop leading from the tank and returning to the tank and one or more spray outlets positioned in the flow loop; the pump, or a further pump, being arranged to cause flow of fluid from the tank through the flow loop, and the apparatus being configured such that, during spraying, only a portion of fluid passing through the flow loop exits through the spray outlets, with the remainder of the fluid returning to the tank for recirculation.

Preferably the flow loop includes one or more spray booms, one or more of the spray outlets being positioned in each spray boom.

Preferably the apparatus includes a spray valve positioned downstream of the spray outlets, the spray valve having an open position and at least one restricted flow position, wherein the pressure at the spray outlets is higher when the spray valve is in the restricted flow position than when it is in the open position.

Preferably the spraying apparatus is configured to spray less than 20% of fluid passing through the flow loop. Preferably the spraying apparatus is configured to spray around 3 to 10% of fluid passing through the flow loop.

Preferably the spraying apparatus is configured to supply fluid to the flow loop at a rate in the range 500 to 800 litres per minute.

Preferably the spraying apparatus includes at least one pressure-actuated closure controlling flow to one or more of the spray outlets, such that fluid is permitted to flow from the flow loop to those one or more spray outlets only when the pressure in the flow line is sufficient to cause the pressure-actuated closure to open.

Preferably the pressure-actuated closure includes a membrane configured to move under sufficient pressure to open the closure.

Preferably the spraying apparatus includes a user-operated override mechanism to prevent undesired opening of the pressure-actuated closure.

Preferably the spraying apparatus is configured as a trailer for towing behind a vehicle or configured to be mounted on a vehicle.

Preferably the spraying apparatus is configured to operate at a pressure less than 35 pounds per square inch. Preferably the spraying apparatus is configured to operate at a pressure less than 30 pounds per square inch. Preferably the spraying apparatus is configured to operate at a pressure less than 25 pounds per square inch.

Preferably the spraying apparatus is configured to maintain a particulate in suspension in the tank for spraying.

Preferably the material to be sprayed is or includes a particulate material and is sprayed in suspension. Preferably the particulate has an average particle size less than 100 microns. Preferably the particulate has an average particle size less than 50 microns. Preferably the particulate has an average particle around 5 microns.

Preferably the material to be sprayed is or includes a component that is biologically active.

Preferably the spraying apparatus is an agricultural or horticultural spraying apparatus.

In a third aspect the invention provides a spraying apparatus including: a tank; a flow loop leading from the tank and returning to the tank; one or more spray outlets positioned in the flow loop; and a pump arranged to cause flow of fluid from the tank through the flow loop; the apparatus being configured such that, during spraying, only a portion of fluid passing through the flow loop exits through the spray outlets, with the remainder of the fluid returning to the tank for recirculation.

Preferably the flow loop includes one or more spray boom, one or more of the spray outlets being positioned in each spray boom.

The flow loop may include two or more spray booms connected in parallel.

Preferably the apparatus includes a spray valve positioned downstream of the spray outlets, the spray valve having an open position and at least one restricted flow position, wherein the pressure at the spray outlets is higher when the spray valve is in the restricted flow position than when it is in the open position.

Preferably the spraying apparatus is configured to spray less than 20% of fluid passing through the flow loop. Preferably the spraying apparatus is configured to spray around 3 to 10% of fluid passing through the flow loop.

Preferably the spraying apparatus is configured to supply fluid to the flow loop at a rate in the range 500 to 800 litres per minute.

Preferably the spraying apparatus includes at least one pressure-actuated closure controlling flow to one or more of the spray outlets, such that fluid is permitted to flow from the flow loop to those one or more spray outlets only when the pressure in the flow line is sufficient to cause the pressure-actuated closure to open.

Preferably the pressure-actuated closure includes a membrane configured to move under sufficient pressure to open the closure.

Preferably the spraying apparatus includes a user-operated override mechanism to prevent undesired opening of the pressure-actuated closure.

Preferably the spraying apparatus is configured as a trailer for towing behind a vehicle or configured to be mounted on a vehicle.

Preferably the spraying apparatus is configured to operate at a pressure less than 35 pounds per square inch. Preferably the spraying apparatus is configured to operate at a pressure less than 30 pounds per square inch. Preferably the spraying apparatus is configured to operate at a pressure less than 25 pounds per square inch.

Preferably the spraying apparatus is configured to maintain a particulate in suspension in the tank for spraying.

Preferably the material to be sprayed is or includes a particulate material and is sprayed in suspension. Preferably the particulate has an average particle size less than 100 microns. Preferably the particulate has an average particle size less than 50 microns. Preferably the particulate has an average particle around 5 microns.

Preferably the material to be sprayed is or includes a component that is biologically active.

Preferably the spraying apparatus is an agricultural or horticultural spraying apparatus.

In a fourth aspect the invention provides a spray arrangement including:
a spray outlet;
an outlet supply line leading to the spray outlet;
a flow line communicating with the supply line but separated therefrom by a pressure-actuated closure, such that fluid is permitted to flow from the flow line to the outlet supply line only when the pressure in the flow line is sufficient to cause the pressure-actuated closure to open.

Preferably the pressure-actuated closure includes a membrane or diaphragm closing an opening when pressure is low but moving to open the opening when pressure in the flow line is sufficient to cause such movement.

### BRIEF DESCRIPTION OF THE DRAWINGS

The invention will now be described by way of example only, with reference to the accompanying drawings, in which:

FIG. 1 is a perspective view of a spraying apparatus according to one embodiment;

FIG. 2 is a top view of the apparatus of claim 1;

FIG. 3 is a partial cross-section through the apparatus of FIG. 2, along the line 3-3;

FIG. 4 is a further top view of the apparatus of claim 1;

FIG. 5 is a partial cross-section through the apparatus of FIG. 4, along the line 5′-5′;

FIG. 5A is a cutaway side view of the apparatus of FIG. 4;

FIG. 6 is a top view of a flow arrangement of the apparatus of FIG. 1;

FIG. 7 is a perspective view of the flow arrangement of FIG. 6;

FIG. 8 is a side view of the flow arrangement of FIG. 6;

FIG. 9 is a further side view of the flow arrangement of FIG. 6;

FIG. 10 is a rear view of the apparatus of FIG. 1;

FIG. 11 is a schematic diagram illustrating flow paths in the apparatus of FIG. 1;

FIG. 12 shows those flow paths marked in a top view of the apparatus of FIG. 1;

FIG. 13 shows a pressure-actuated closure from the apparatus of FIG. 1 in a closed position;

FIG. 14 shows the closure of FIG. 13 in an open position;

FIG. 15 is a perspective view of a further embodiment of spraying apparatus;

FIG. 16 shows part of the flow arrangement of the apparatus of FIG. 15;

FIG. 17 is a schematic view of the flow arrangement of the apparatus of FIG. 15

FIG. 18 is a rear view of part of the apparatus of FIG. 15;

FIG. 19 is a side view showing part of the flow arrangement of the apparatus of FIG. 15;

FIG. 20 is a cut-away view showing the mixing unit of the apparatus of FIG. 15;

FIG. 21 is a perspective view of an inlet unit from the mixing unit;

FIG. 21a is a side view of the inlet unit;

FIG. 22 is a plan view of the apparatus of FIG. 15;

FIG. 23 is a side view of the apparatus of FIG. 15;

FIG. 24 is a perspective view of an inlet unit of the apparatus of FIG. 15;

FIG. 25 is a further perspective view of the inlet unit; and

FIG. 26 is a side view of the inlet unit.

### DETAILED DESCRIPTION

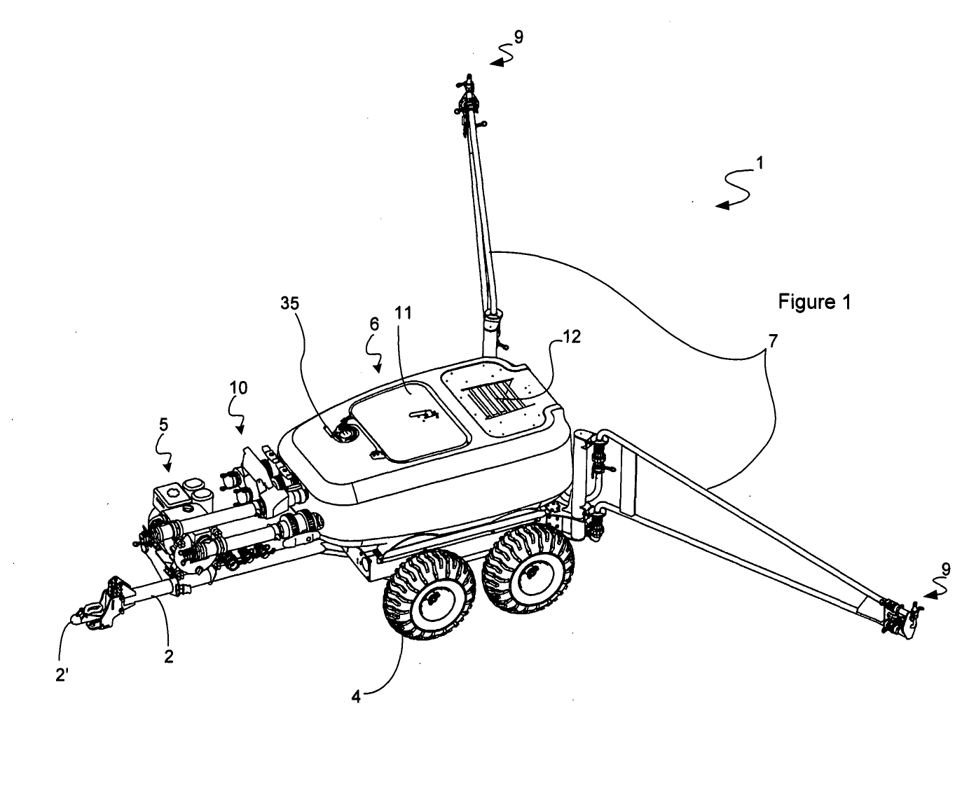

FIG. 1 shows a spraying apparatus 1 configured as a trailer unit for towing behind a vehicle. The apparatus 1 includes a towbar 2 with a suitable coupling 2′ for connection to the towing vehicle. The apparatus is supported on a number of wheels 4.

The apparatus 1 includes a pump 5, tank 6 and one or more spray booms 7. The pump operates to supply spray fluid from the tank 6 through the spray booms 7 to spray outlets 9.

The pump 5 may be any suitable pump for maintaining the required pressures and flow rates. The pump is preferably connected to a flow manifold 10, the function of which will be discussed further below.

The tank 6 may be formed of any suitable material, preferably of moulded plastic. The tank 6 has an opening with a lid 11 which allows fluids (e.g. water) and some spray materials to be added to the tank, and also allows user access to the tank interior. The word “fluid” is used in this specification to mean liquids and solutions but also suspensions of particulates in fluids.

A further intake 12 allows spray materials to be added and forms part of a mixing unit for enhanced mixing of the spray materials and fluids. The intake may simply be open, or covered by a grill as shown in FIG. 1, or could have a removable cover. The mixing unit will be discussed in detail below.

In a preferred embodiment the spray booms 7 form part of a closed flow loop. That is, fluid to be sprayed flows from the tank to the spray booms and then back to the tank. Only a part of the fluid circulating in this way is sprayed from the outlets 9 with any one circulation.

In the embodiment shown the spray booms 7 are mounted to fold back along the sides of the tank 6 for ease of transport and to fold out to the operating position of FIG. 1. However, in other embodiments the spray boom may be fixed or indeed no spray boom need be provided. For example, a flow path could lead to single spray outlet positioned underneath or at the rear of the tank 6.

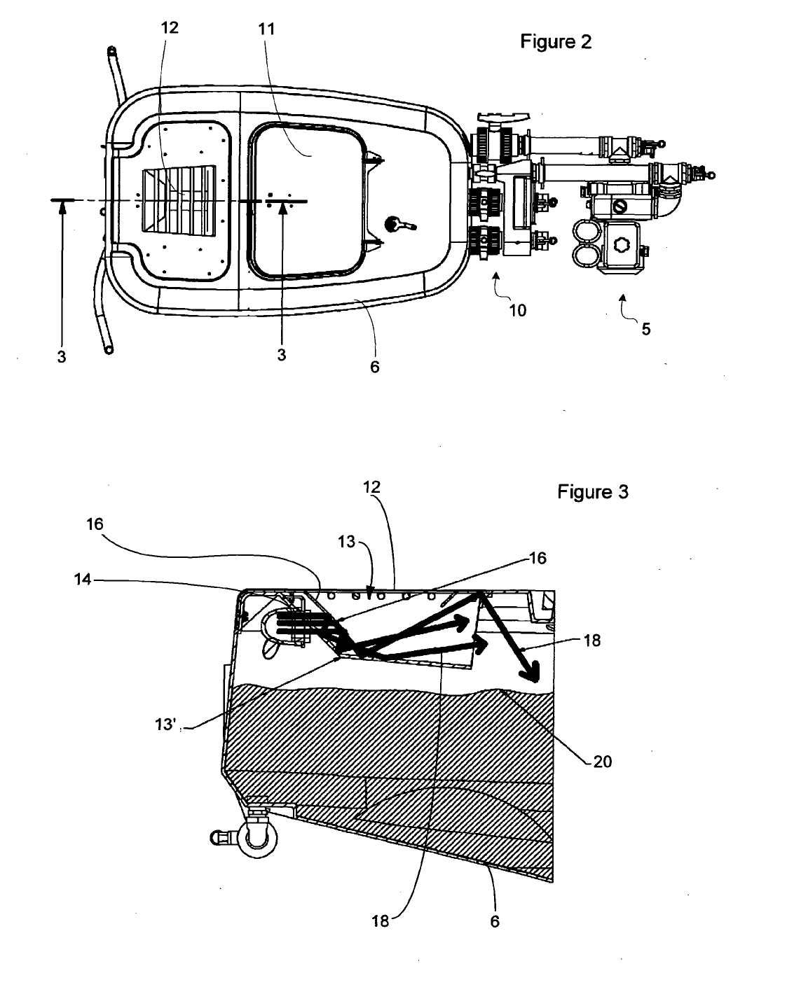

The mixing unit will now be described with reference to FIGS. 2 and 3. FIG. 2 is a top view of the apparatus 1 (excluding the spray booms 7). FIG. 3 is a cross-section along the line “3-3” from FIG. 2. This shows how the intake 12 leads to a mixing chamber 13 formed as a chute 13′, which is preferably formed integrally with the tank 6 during moulding. Fluid is introduced into the mixing chamber 13 from a fluid inlet 14. The mixing unit is configured to cause turbulent flow so as to increase the mixing between material added via the intake 12 and fluid introduced through the fluid inlet 14. In the embodiment shown, a baffle 16 diverts fluid entering from the fluid inlet 14 to create this turbulent flow, as indicated by the arrows 18. However, any suitable arrangement of surface or structural features, plates, obstructions, baffles, walls, ramps, deflectors etc may be used. Alternatively, turbulent flow could be created simply through the shape of the mixing chamber 13 and/or the position of the fluid inlet 14.

After mixing, the mixed spray material and fluid passes into the tank 6. The level of fluid or suspension in the tank 6 is marked 20 in FIG. 3. For the avoidance of doubt, the term “fluid” includes solutions or suspensions incorporating such spray materials.

Once all material to be sprayed has been added to the tank, flow to the mixing unit could be switched off. However, in a preferred embodiment some level of flow is maintained to the fluid inlet 14 substantially continuously while the spraying apparatus 1 is in operation. This helps to prevent any clogging in the mixing unit, or flow conduits leading to the mixing unit, particularly where particulates are being sprayed.

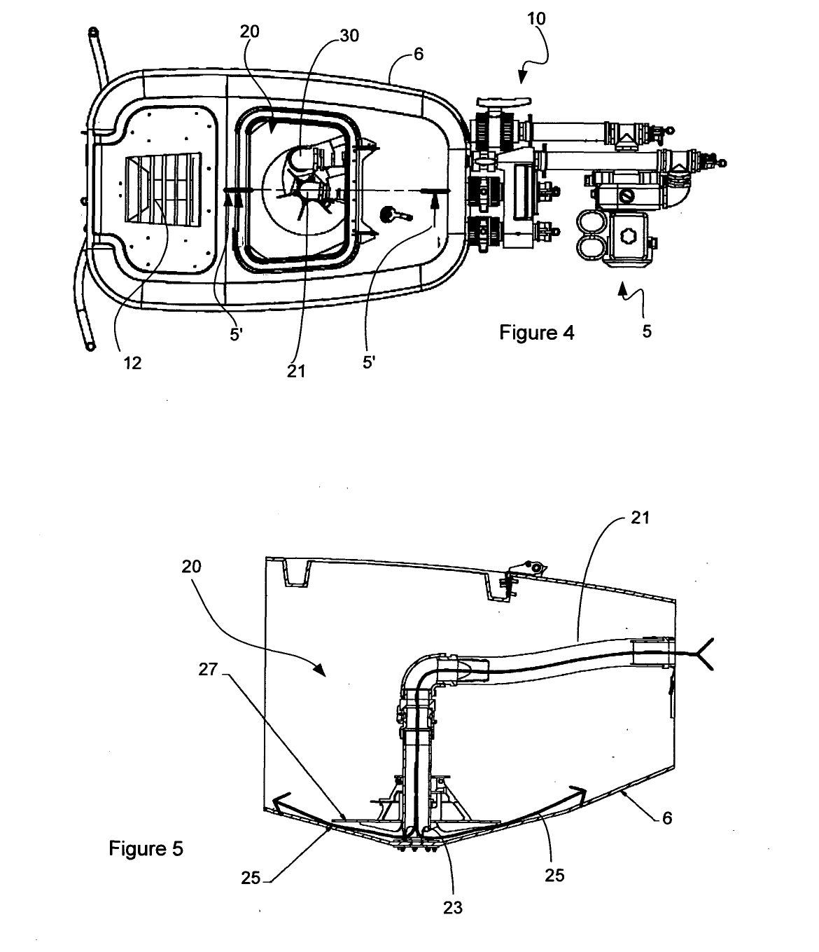

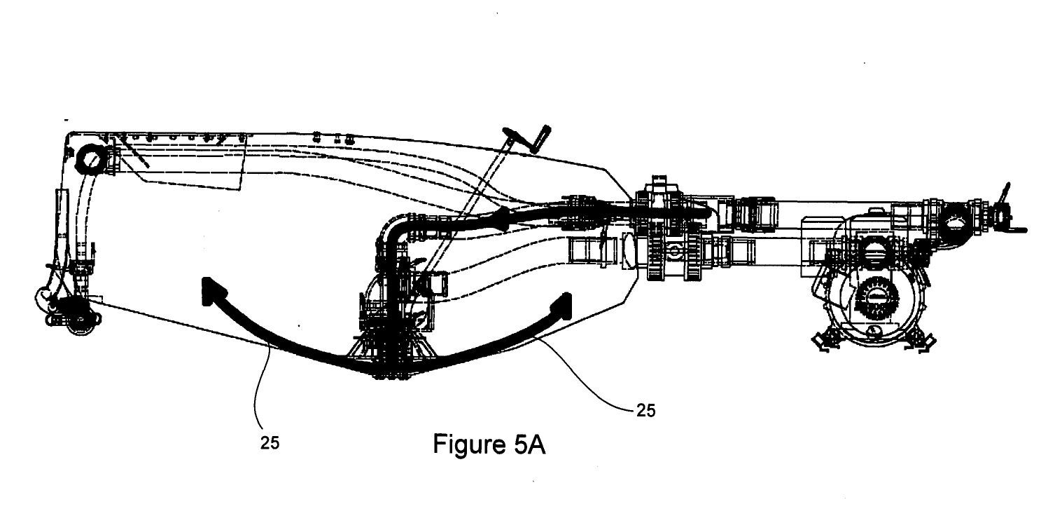

FIG. 4 is a further top view of the apparatus 1, this time showing the tank 6 with the cover 11 removed. FIG. 5 is a cross-section along the line 5′-5′ from FIG. 4. These figures show a flow arrangement 20. A flow conduit 21 is connected to the manifold 10 such that the pump pumps fluid through that conduit 21 into the tank 6. The flow arrangement 20 includes a fluid inlet 23 positioned at the end of the flow conduit 21. Flow is therefore directed downwards towards the bottom of the tank and the positions of the inlet 23 and the bottom of the tank 6 create flow substantially across the bottom of the tank (at least in the region of the inlet 23) as indicated by arrows 25 (see also FIG. 5A). This flow pattern creates a circular “curtain” flow, with the fluid or suspension in the tank constantly moving and any particulate settling towards the bottom of the tank is swept upwards in this flow. Preferably the fluid inlet is positioned substantially at or near the bottom of the tank. In the embodiment of FIG. 4 the fluid inlet is also positioned substantially in the middle of the tank (i.e. when viewed from above). However, in some embodiments the fluid inlet may be positioned towards the back, front or one side of the tank. Furthermore, more than one fluid inlet may be used.

FIG. 5 also shows a baffle 27, which in the embodiment shown is in the form of a plate. The baffle 27 helps to direct the flow outwards across the bottom of the tank 6. In addition, as will be discussed below, the baffle is adjustable within the tank. This allows pressure to be regulated and also allows the plate to be raised to release any blockage that may eventuate around the inlet 23. Furthermore, this adjustment allows the user to adjust the flow patterns and turbulence within the tank for suspensions of different viscosities.

FIG. 4 also shows the position of an outflow conduit 30. Although not shown in FIG. 5 the outflow conduit draws fluid or suspension from just above the baffle plate, i.e. near the inlet opening 23 but on the other side of the baffle 27. Thus inflow and outflow occur in the same part of the tank, which helps to create the circular “curtain” flow discussed above. Flow passes from the inlet outwards across the bottom of the tank, upwards and then back down towards the inflow. In practice, this flow may be irregular and turbulent, but in any case creates sufficient circulation within the tank to maintain particulates in suspension.

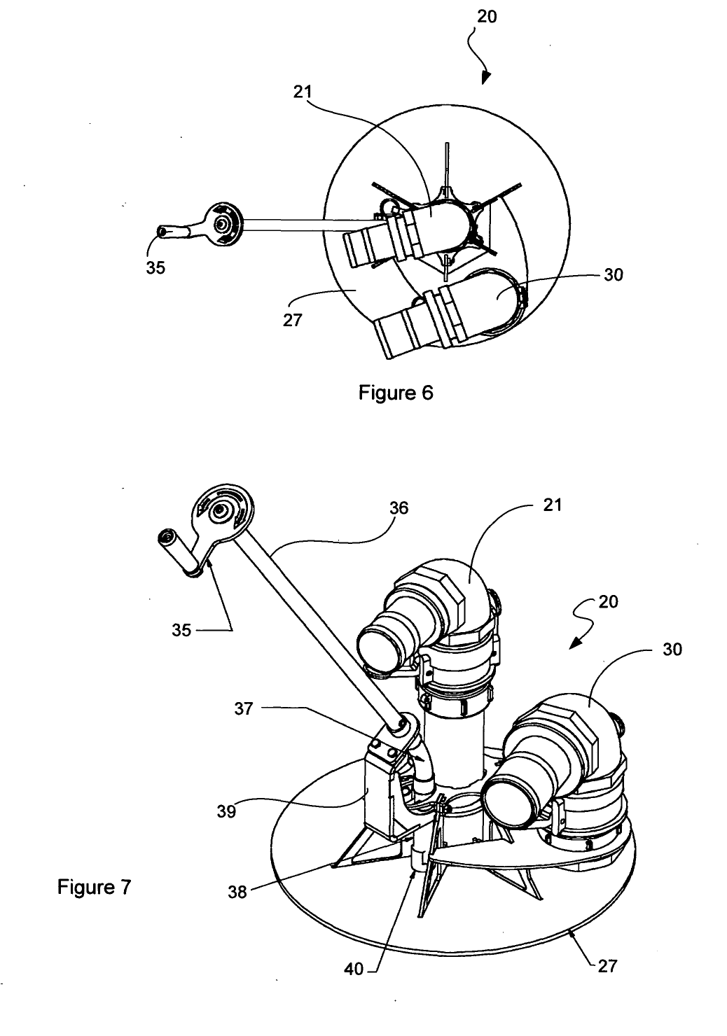

FIGS. 6 and 7 are top and perspective views of the flow arrangement 20.

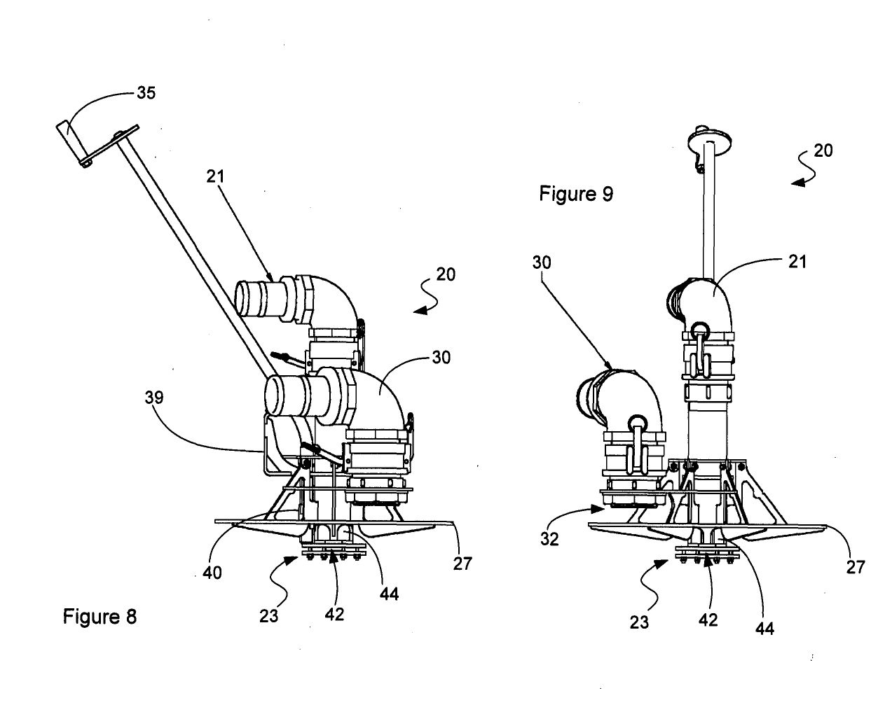

FIGS. 8 and 9 are two different side views of the flow arrangement 20. These figures more clearly show the position of the inlet opening 23 below the baffle 27 and the outflow opening 32 above the baffle 27.

FIGS. 6 to 9 also show an adjustment mechanism for altering the position of the baffle 27 within the tank 6. A handle 35 is attached to a shaft 36, and protrudes from the top of the tank 6 as shown in FIG. 1. The shaft 36 is supported by a bracket 39 and connected via a flexible coupling section 37 to a vertical section 38 which, when driven to rotate by the handle 35, rides up or down in a threaded nut 40 attached to the baffle plate 27. The end of the vertical section 38 is rotatably mounted on a lower plate assembly 42, which is also used to mount the flow arrangement 20 to the bottom of the tank 6. The flow inlet 23 may be formed by a number of cut away openings 44 above the lower plate assembly.

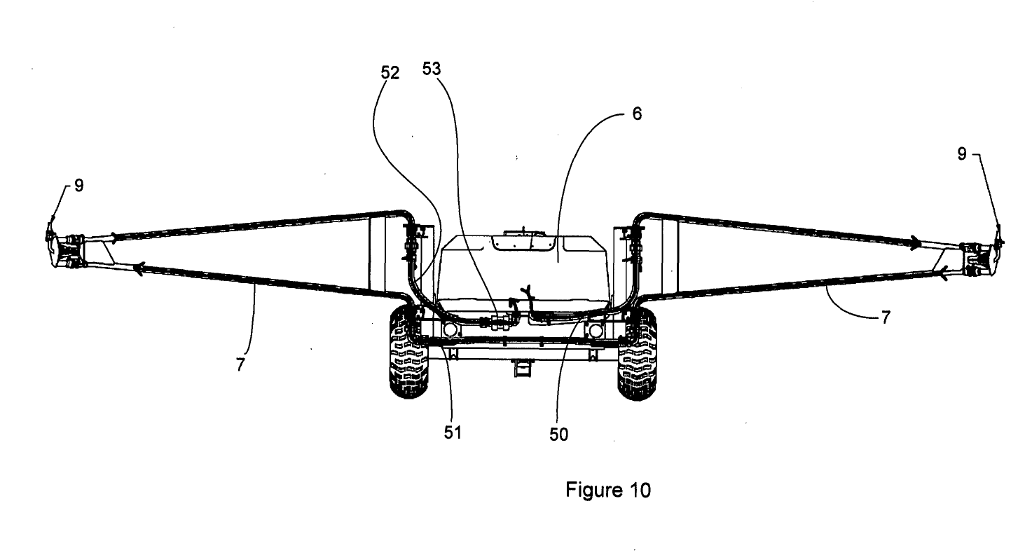

FIG. 10 is a rear view showing flow through a spray loop. In the embodiment shown, the spray loop includes the spray booms 7, a flow conduit 50 leading from the pump 5 or manifold 11, a flow conduit 51 connecting the two booms 7, and a flow conduit 52 returning from the second boom to the tank 6. A flow restricting valve 53 connects the flow conduit 52 back to the tank 6, so as to maintain adequate pressure in the spray loop.

Thus, spray fluid is pumped through the spray loop with only a portion of that fluid exiting through the spray outlets. That portion may be less than 2%, but is preferably less than 20%, ideally around 3 to 10% by volume. The Applicant's recirculating flow path provides excellent performance with liquid suspended fertilizers.

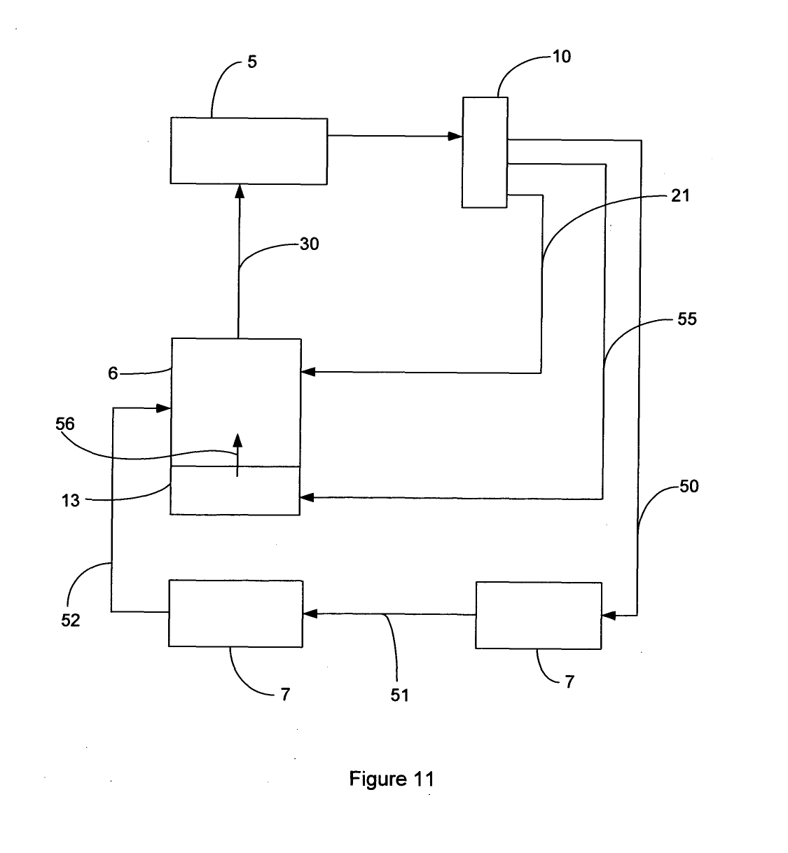

Various components of the spraying apparatus have been described. FIG. 11 is a schematic diagram showing the flow paths used between those components in one embodiment.

The pump 5, via flow conduit 30, takes fluid or suspension from the tank 6 and pumps that fluid into a manifold 10. The manifold has three outlets. Adjustable valves may be associated with one or more of those outlets in some embodiments. A first outlet leads back to the tank 6 via flow conduit 21, to maintain flow within the tank 6 as discussed above. A second outlet leads via flow conduit 55 to the fluid inlet 14 of mixing unit or chute 13. The mixing unit or chute 13 drains into the tank 6, as discussed above and indicated by arrow 56 in FIG. 11. The manifold's third outlet leads to the spray loop, through flow conduits 50, 51 and 52 and spray booms 7, and returns to the tank 6. Thus, the Applicant's system manages all flow using a single pump. However, in some embodiments more than one pump (with or without one or more manifolds) may be used.

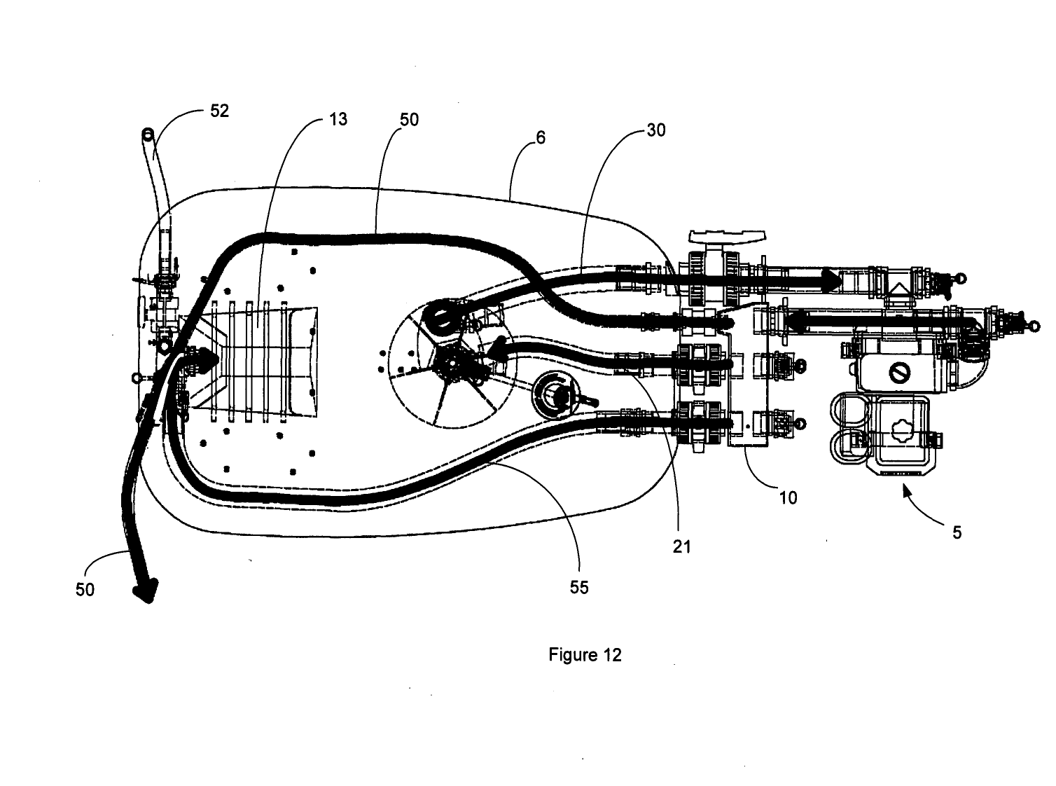

FIG. 12 is a top view of the spraying apparatus 1, showing how the flow paths may be arranged physically.

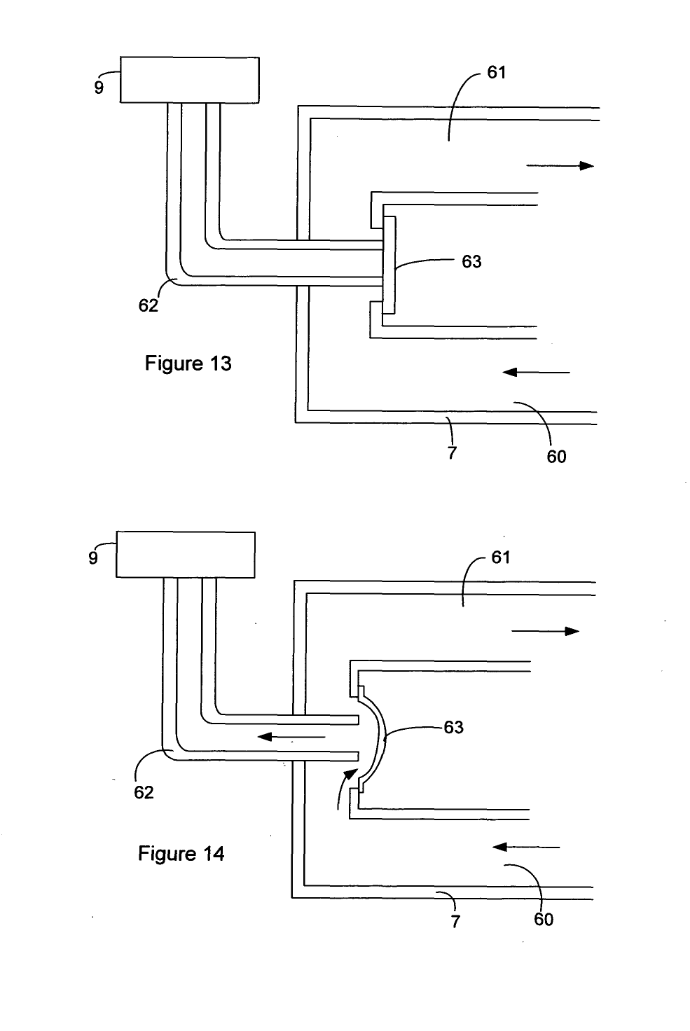

FIG. 13 shows a mechanism for controlling flow near the spray outlet 9. Spray fluid is pumped along a first leg 60 of the spray boom 7 and returns along a second leg 61 of the spray boom 7. The spray outlet 9 is mounted on an outlet supply line 62, which is connected into the spray boom 7. The outlet supply line has a smaller diameter than the spray boom 7, such that spray fluid can flow through the spray boom past the outlet supply line 62. A membrane or diaphragm 63 is mounted in the spray boom 7 such that it seals the end of the outlet supply line 62 in the closed position of FIG. 13. When the pressure in the spray boom 7 is sufficient, the pressure will force the membrane or diaphragm 63 to the open position of FIG. 14, allowing spray fluid to pass into the outlet supply line 62 and on to the spray outlet 9.

Thus, the membrane or diaphragm provides a pressure actuated closure which prevents flow to the spray outlet 9 when the pressure is low. When the pressure rises sufficiently, the pressure actuated closure opens to allow spraying to commence. The level of pressure required to open this closure may be set using a suitable pressure or bias applied to the back of the membrane or diaphragm 63, and that pressure or bias could even be adjustable to allow the pressure threshold to be adjusted by a user. Furthermore, a user operated override mechanism such as a mechanical lock can be provided to prevent opening of the closure, which may be useful for example when towing the apparatus on public roads or over farmland to an area to be sprayed.

The embodiment shown has the spray nozzles standing up from the spray boom. However, the spray nozzles could hang down from the spray boom and this may help them to drain, further reducing the chance of clogging.

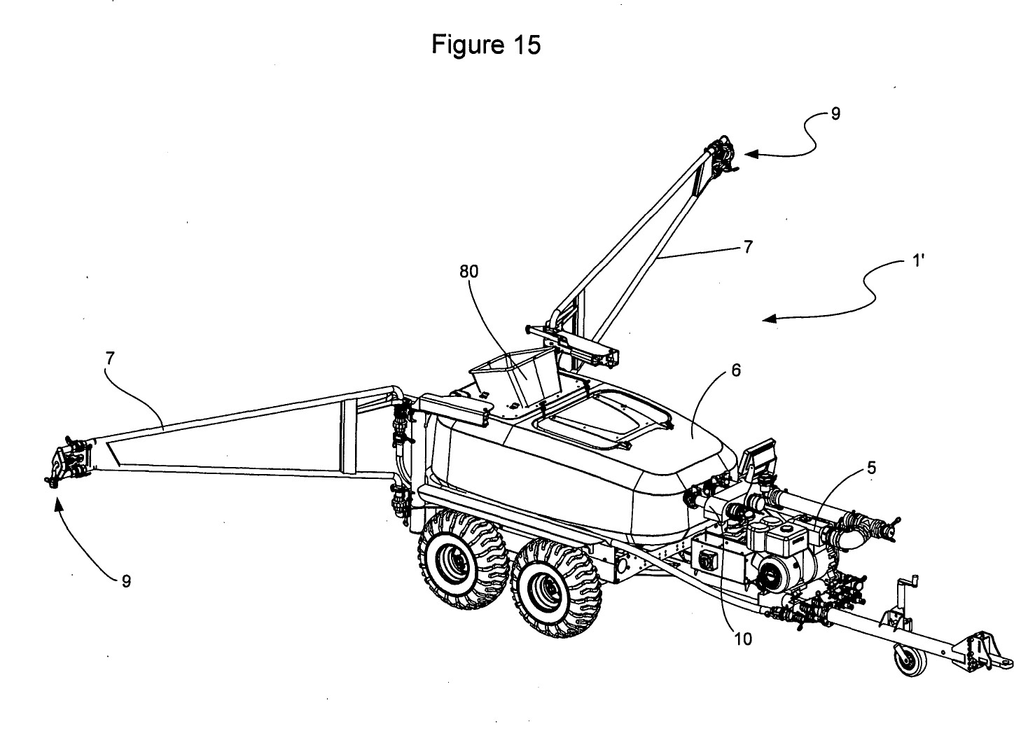

FIGS. 15 to 25 show a further embodiment of the invention. The spraying apparatus 1′ of this embodiment operates in a generally similar manner to the embodiment of FIGS. 1 to 14 and similar alternatives may be used to those described above.

FIG. 15 shows the spraying apparatus 1′ in the form of a trailer apparatus for towing behind a vehicle. The apparatus 1′ includes a pump 5, tank 6 and one or more spray booms 7. The pump operates to supply spray fluid from the tank 6 through the spray booms 7 to spray outlets 9. This embodiment uses spray nozzles that hang downwards from the spray boom 7.

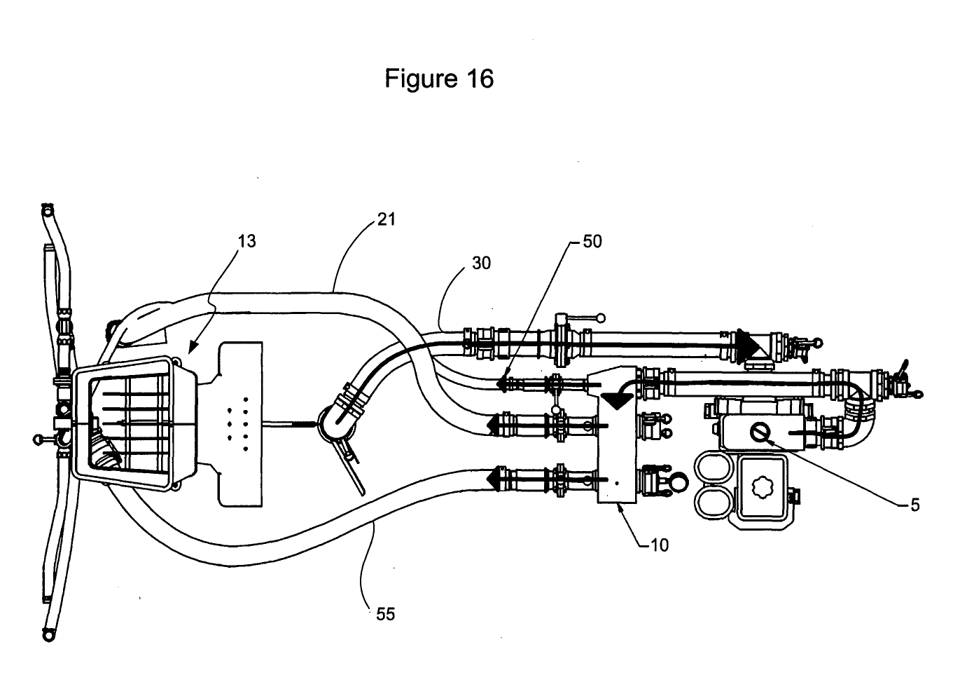

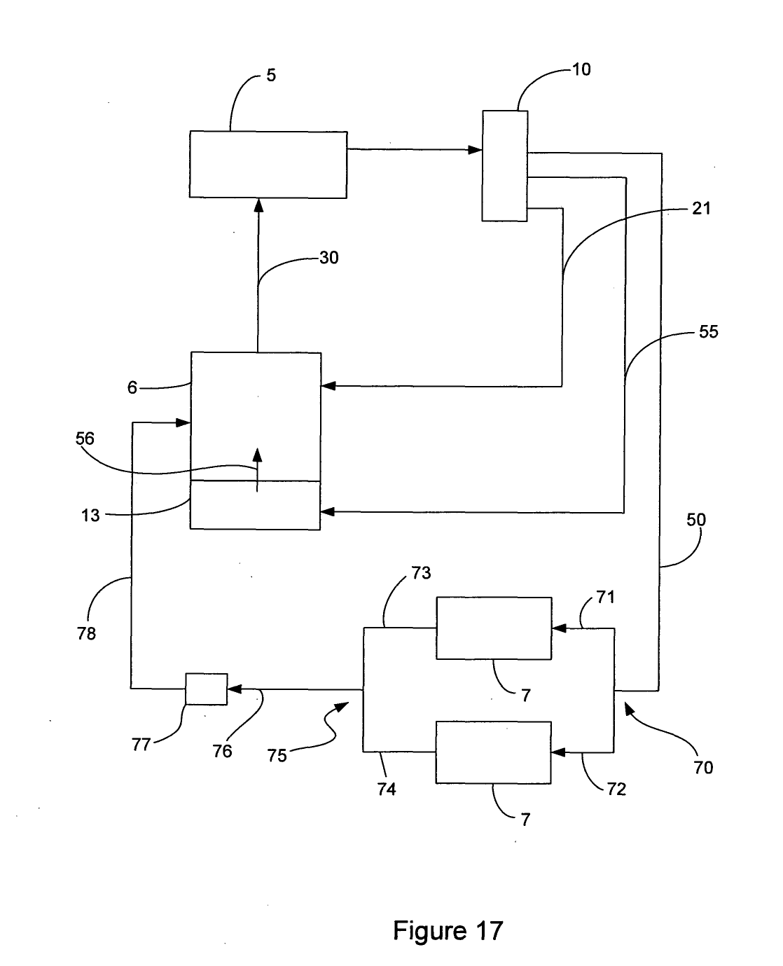

FIGS. 16 and 17 show the flow paths of this embodiment. In FIG. 16 the tank structure is not shown, for clarity, while FIG. 17 is a schematic diagram.

The pump, via flow conduit 30, takes fluid or suspension from the tank 6, preferably from a point in the middle and near the bottom of the tank, and pumps that fluid into a manifold 10. The manifold has three outlets. Adjustable valves may be associated with one or more of those outlets in some embodiments. A first outlet leads back to the tank 6 via flow conduit 21, to maintain flow within the tank 6. In this embodiment the tank inlet is different to that of FIGS. 1 to 14 and will be described in more detail below. A second outlet leads via flow conduit 55 to the fluid inlet 14 of mixing unit or chute 13. The mixing unit or chute 13 drains into the tank 6, as discussed above and indicated by arrow 56 in FIG. 17.

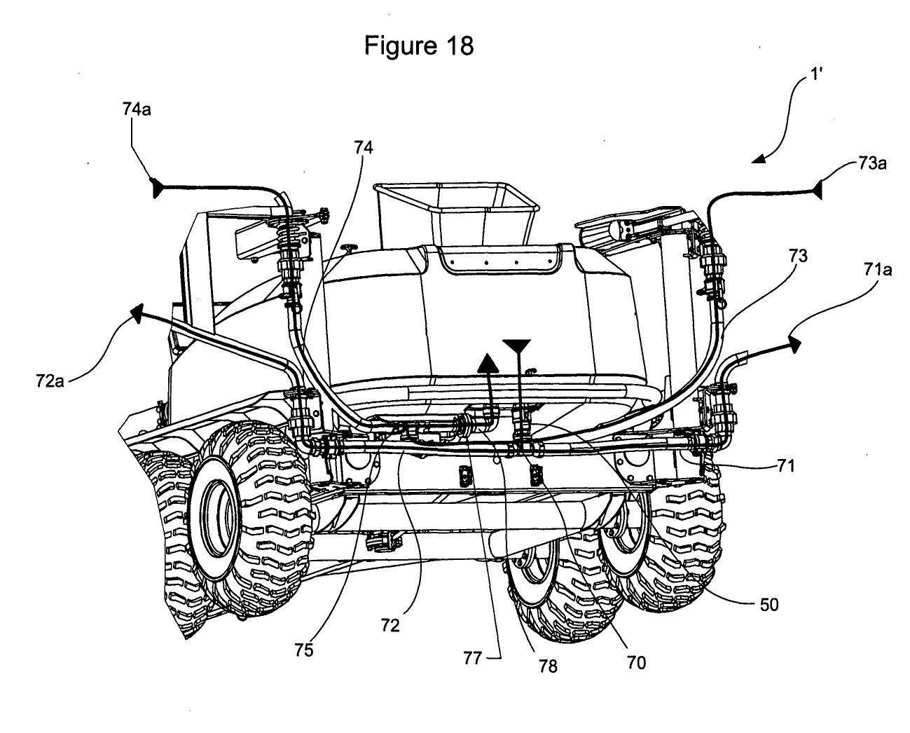

The manifold's third outlet leads to the spray loop and is more clearly shown in FIG. 18 (in which the spray booms 7 are not shown). This outlet leads through flow conduit 50 to a junction 70, which connects to two flow lines 71, 72 each leading to a spray boom 7 (as indicated by arrows 71a and 72a in FIG. 18). The spray booms are connected (as indicated by arrows 73a and 74a in FIG. 18) to further flow lines 73, 74 and thence to a further junction 75. Flow conduit 76 leads from the further junction 75 to a spray control valve 77. A further flow conduit 78 leads from the spray control valve back to the tank 6.

In this embodiment the spray booms 7 are therefore connected in parallel rather than in series. This provides a more even pressure to the two booms.

In this embodiment the spray pressure is controlled by the spray control valve 77. This valve has a first, open position in which fluid or suspension can flow freely through the flow paths 50, 71, 72, 73, 74, 76, 78 and booms 7. In this position pressure does not build up significantly in the booms 7 and this pressure is not sufficient to actuate the mechanism of FIGS. 13 and 14 described above. Therefore, when the spray control valve is open fluid or suspension is not sprayed.

The spray valve 77 also has a second, restricted flow position. In this position flow through the valve is restricted, and this creates a higher pressure in the flow conduits 50, 71, 72, 73, 74, 76 and booms 7. This higher pressure is sufficient to actuate the mechanism of FIGS. 13 and 14, so when the spray control valve is in this restricted flow position, fluid or suspension is sprayed.

The spray control valve may be continuously adjustable (as opposed to simply having open and restricted positions) so as to provide different levels of flow restrictions and therefore continuously adjustable pressure in the spray booms. The spray control valve may be controlled remotely from the vehicle towing the spraying apparatus, using any suitable mechanical, wired or wireless control system.

Thus, this embodiment also manages all flow using a single pump. However, in some embodiments more than one pump (with or without one or more manifolds) may be used.

Suitable filters may be provided to prevent blocking of the spray booms.

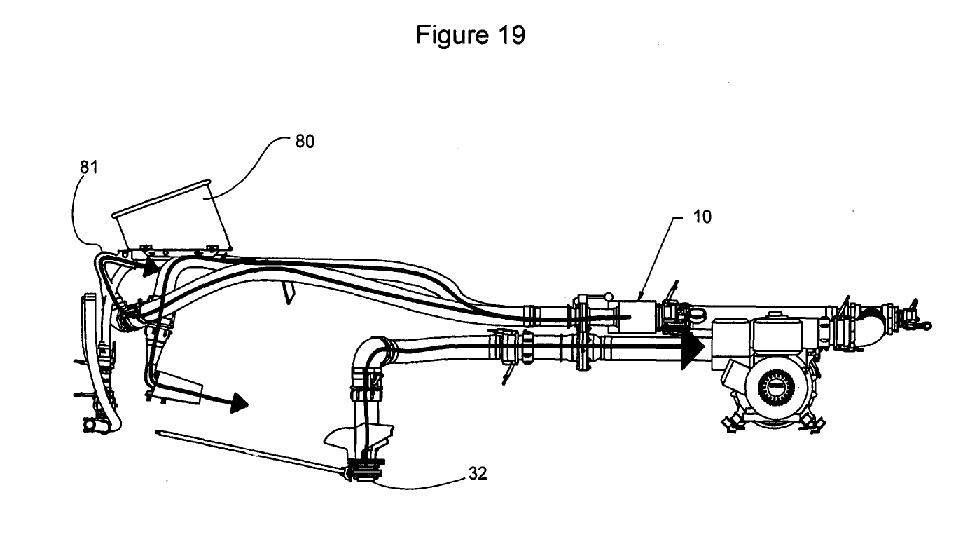

The mixing unit will now be described with reference to FIGS. 19 to 21A. In this embodiment the mixing unit includes an upstand 80 that helps to prevent splashing of material or fluid out of the mixing unit. As in the first embodiment, a user pours spraying material into the mixing unit and it is mixed before passing into the main part of the tank 6.

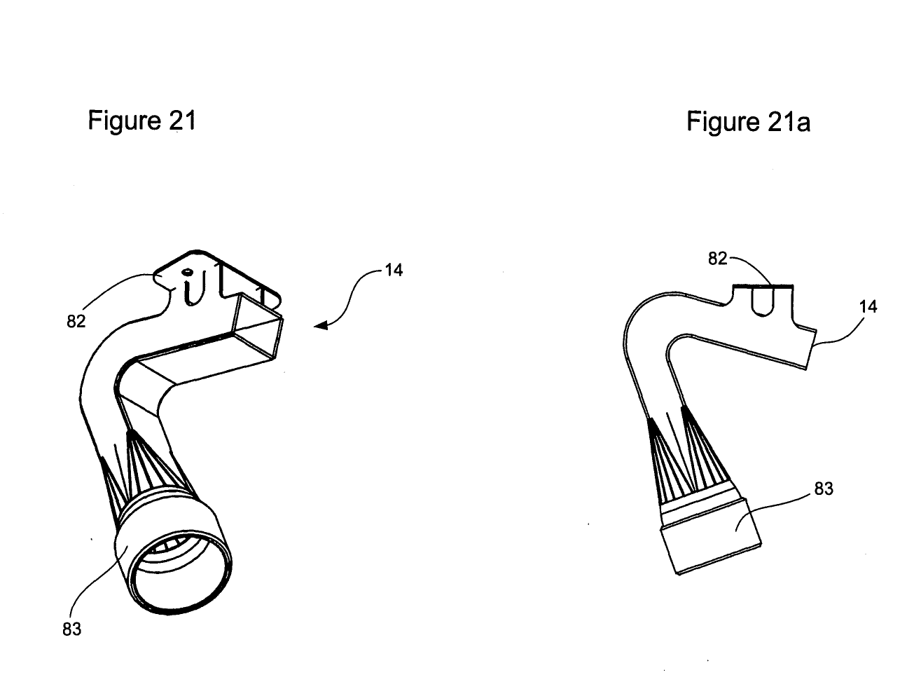

In this embodiment the flow conduit 55 leads from the manifold into an inlet unit 81 having an inlet opening 14. The inlet unit 81 is shown in more detail in FIGS. 21 and 21A. The inlet unit includes a mounting bracket 82 for mounting to the tank structure. The conduit 55 connects to a connection section 83 and the inlet unit has a smooth curve from the connection section to a square cross-section inlet opening 14. This smooth curve helps to maintain smooth laminar flow of fluid or suspension out of the inlet opening 14. Smooth flow at this stage again helps to prevent splashing of fluid or suspension out of the mixing unit.

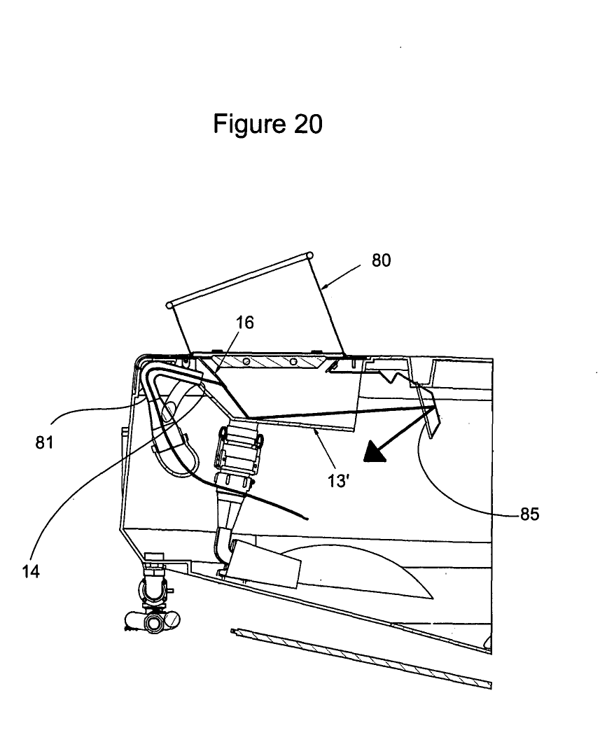

The fluid or suspension is immediately diverted by a baffle 16 (FIG. 20) to promote mixing of the fluid or suspension and new material (e.g. powder) introduced by the user. The mixing unit also includes a further deflector or baffle 85. The combined fluid or suspension and new material is then forced against that further deflector or baffle 85 to disrupt the flow and ensure adequate mixing of the new material into the fluid or suspension. Preferably substantially smooth or laminar flow is maintained up until the flow strikes this further deflector or baffle 85. The flow then becomes turbulent when the fluid is forced against the further deflector or baffle 85. This deflector may be a simple plate or may be a more complex obstacle, for example with a number of bars positioned in front of a plate. The mixed fluid or suspension then passes downwards into the main tank 6.

The main tank inlet and agitator will now be described with reference to FIGS. 19, 20 and 22 to 26. The fluid inlet 23 may be positioned towards the back of the tank, unlike the embodiment of FIGS. 1 to 14 where the inlet is positioned centrally and near to the outlet 30. In this embodiment the inlet is also positioned away from the outflow opening 32.

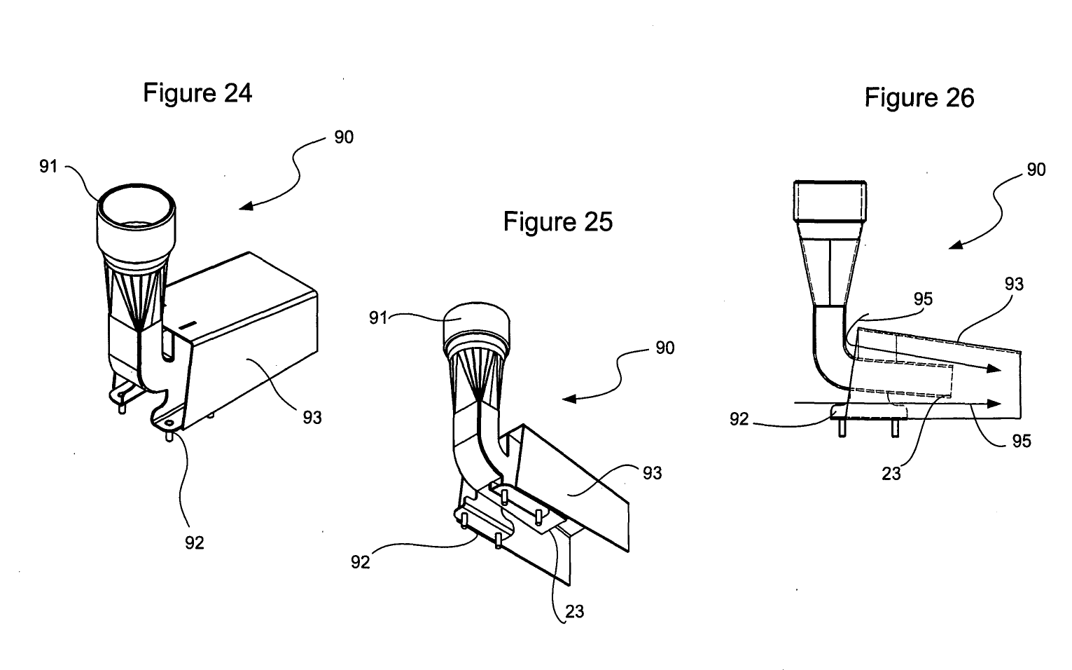

The fluid inlet 23 may be provided as part of an inlet unit 90 as shown in FIGS. 24 to 26. The inlet unit 90 includes a connection section 91 for connection of the flow conduit 21 and is mounted to the tank structure by mounting section 92. Fluid or suspension passes from the connection section 91 to the fluid inlet 23. The inlet unit 90 also includes a shroud 93 in order to form a Venturi, with flow of fluid or suspension from the fluid inlet 23 promoting flow of fluid or suspension from the tank through the shroud 93 as indicated by the arrows 95 in FIG. 26. This helps to agitate or create turbulence within the tank 6. Any suitable Venturi arrangement may be used instead of the shroud 93 and many suitable configurations will occur to the skilled reader.

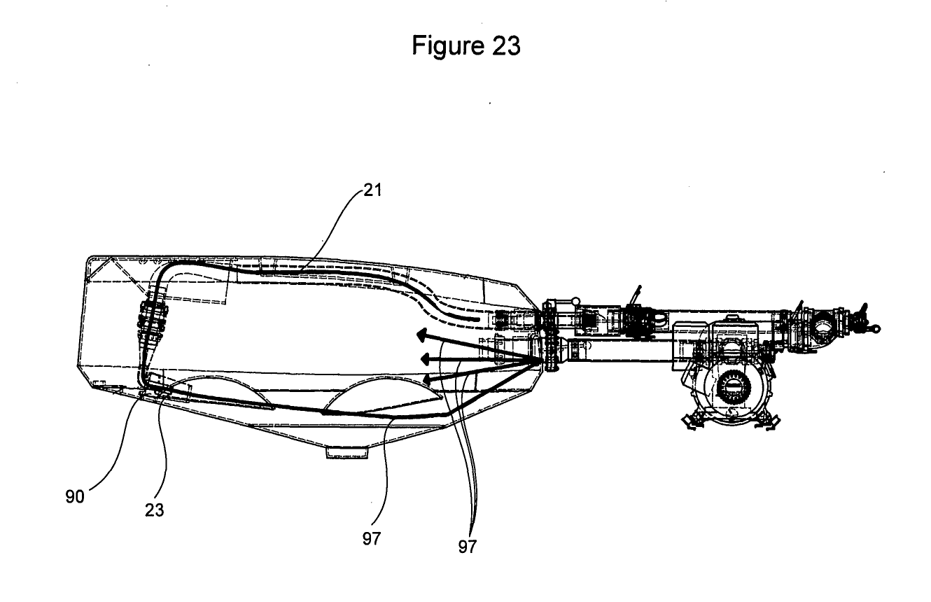

As shown in FIG. 23 the inlet unit may be generally directed along the bottom of the tank in order to create flow in this region and prevent settling of particulates out of suspension. Flow from the inlet unit tends to go across the bottom of the tank before hitting the (preferably curved) inner surfaces of the tank 6, creating further turbulence and agitation within the tank 6 as indicated by the arrows 97.

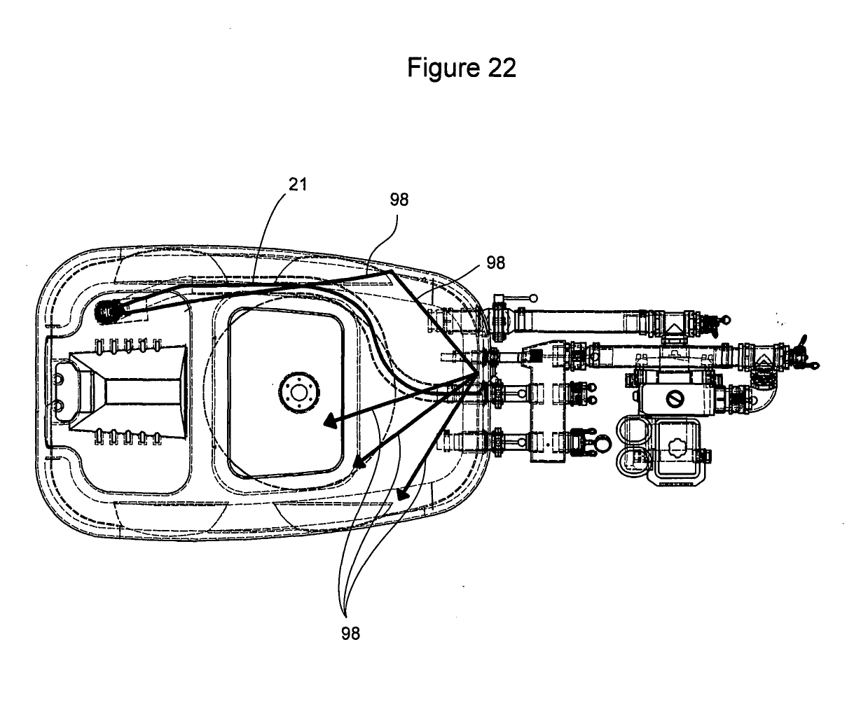

As shown in FIG. 22 the inlet unit may be directed slightly to one side, i.e. towards but at an acute angle to a side wall of the tank, such that the flow is directed towards a side wall of the tank 6, in order to create further turbulence and agitation, as indicated by arrows 98.

The invention may be applied to various spraying systems, including systems configured as trailers for towing behind vehicles and vehicle mounted spraying systems.

The system preferably operates to supply fluid to the spray loop at around 500 to 800 litres per minute. Fluid is preferably supplied at a pressure less than 35 pounds per square inch, more preferably less than 25 pounds per square inch. This low pressure helps to prevent damage to biologically active components of the spray material or fluid. Where particulates are to be sprayed, these will preferably have an average particle size less than 100 microns, preferably less than 50 microns, more preferably around 5 microns.

The Applicant's system provides for improved initial mixing of powders into a fluid using a mixing unit, as described above. This means that insoluble powders move effectively and quickly into suspension and are less likely to float on the fluid surface.

Once a suspension has been formed, the agitator arrangement maintains the particulates in suspension by maintaining flow across the bottom of the tank and preferably in a turbulent flow elsewhere in the tank, for example in the circular “curtain” or donut shape described above. In contrast to mechanical mixers or the like, this flow agitation is robust, less prone to failure and can be powered by the same pump used to apply spray.

The recirculating spray loop is arranged to apply only a portion of spray from the spray outlets with each circulation. This also helps to keep the fluid moving, maintaining the suspension and preventing clogging around the spray outlets.

The Applicant's apparatus is therefore extremely effective for application of all sprays and in particular for application of liquid suspended sprays. The features discussed above allow very thick suspensions to be formed, maintained and sprayed. This means that a sprayer of a given size can apply spray to a larger area before refilling. The Applicant's system may be suitable for applying spray to around 1 hectare in 3 minutes, using a 14 metre swathe.

Any suitable spray materials may be used, including lime, magnesium sulphate, seaweed and other fertilizers, including urea, diammonium phosphate (DAP) fertilizers, bio-fertilizers (which may include nutrients and/or living bacteria or other organisms). All manner of fine ground insoluble or soluble fertilizers may be used. Liquid, soluble solid and insoluble powders can all be sprayed.

The apparatus is suited to spraying in agricultural and horticultural applications, but may also find application in other areas.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and methods, and illustrative examples shown and described. Accordingly, departures may be made from such details without departure from the spirit or scope of the Applicant's general inventive concept.

1-32. (canceled)

33. An agricultural or horticultural spraying apparatus including:
i) a mixing unit with an intake for introduction of a material to be sprayed into the mixing unit and a fluid inlet for introduction of fluid into the mixing unit; and
ii) a tank, an outlet from the mixing unit leading directly or indirectly to the tank;
wherein the mixing unit is configured to cause turbulent flow of fluid that is introduced from the fluid inlet to promote mixing of the material and the fluid.

34. A spraying apparatus as claimed in claim 33 wherein the material to be sprayed is or includes a particulate material.

35. A spraying apparatus as claimed in claim 33 wherein one or more structural features are provided within the mixing unit to cause the turbulent flow.

36. A spraying apparatus as claimed in claim 35 wherein the structural features include one or more features from the group: plates, obstructions, baffles, walls, ramps, deflectors.

37. A spraying apparatus as claimed in claim 33, including a pump arranged to cause fluid to flow from the tank to the fluid inlet for introduction of fluid into the mixing unit, the fluid then flowing from the mixing unit back to the tank.

38. A spraying apparatus as claimed in claim 37, wherein the pump is arranged to maintain a recirculating flow from the tank through the mixing unit and back to the tank substantially continuously while the spraying apparatus is in use.

39-47. (canceled)

48. A spraying apparatus as claimed in claim 33 configured as a trailer for towing behind a vehicle or configured to be mounted on a vehicle.

49. A spraying apparatus as claimed in claim 33 configured to operate at a pressure less than 35 pounds per square inch.

50-51. (canceled)

52. A spraying apparatus as claimed in claim 33 configured to maintain a particulate in suspension in the tank for spraying.

53-58. (canceled)

59. An agricultural or horticultural spraying apparatus including:
i) a tank;
ii) a flow loop leading from the tank and returning to the tank;
iii) one or more spray outlets positioned in the flow loop; and
iv) a pump arranged to cause flow of fluid from the tank through the flow loop;
the apparatus being configured such that, during spraying, only a portion of fluid passing through the flow loop exits through the spray outlets, with the remainder of the fluid returning to the tank for recirculation.

60. A spraying apparatus as claimed in claim 59 wherein the flow loop includes one or more spray booms, one or more of the spray outlets being positioned in each spray boom.

61. A spraying apparatus as claimed in claim 60 wherein the flow loop includes two or more spray booms connected in parallel.

62. A spraying apparatus as claimed in claim 59, including a spray valve positioned downstream of the spray outlets, the spray valve having an open position and at least one restricted flow position, wherein the pressure at the spray outlets is higher when the spray valve is in the restricted flow position than when it is in the open position.

63. A spraying apparatus as claimed in claim 59 configured to spray less than 20% of fluid passing through the flow loop.

64. (canceled)

65. A spraying apparatus as claimed in claim 59 configured to supply fluid to the flow loop at a rate in the range 500 to 800 litres per minute.

66. A spraying apparatus as claimed in claim 59, further including at least one pressure-actuated closure controlling flow to one or more of the spray outlets, such that fluid is permitted to flow from the flow loop to those one or more spray outlets only when the pressure in the flow line is sufficient to cause the pressure-actuated closure to open.

67-68. (canceled)

69. A spraying apparatus as claimed in claim 59 configured as a trailer for towing behind a vehicle or configured to be mounted on a vehicle.

70. A spraying apparatus as claimed in claim 59 configured to operate at a pressure less than 35 pounds per square inch.

71-72. (canceled)

73. A spraying apparatus as claimed in claim 59 configured to maintain a particulate in suspension in the tank for spraying and to spray the particulate in suspension.

74. (canceled)

75. A spraying apparatus as claimed in claim 73 wherein the particulate has an average particle size less than 100 microns.

76-81. (canceled)
